(19) United States
(12) Patent Application Publication
(10) Pub. No.: US 2026/0312827 A1
(43) Pub. Date: Oct. 8, 2026

(54) Attribute Certificate Having Additional Cryptographic Information Relating to a Digital Certificate

(71) Applicant: Siemens Aktiengesellschaft, München (DE)

(72) Inventors: Rainer Falk, München (DE); Steffen Fries, München (DE)

(73) Assignee: Siemens Aktiengesellschaft, München (DE)

(21) Appl. No.: 19/481,224

(22) PCT Filed: Apr. 12, 2024
(86) PCT No.: PCT/EP2024/059982

§ 371 Date: Nov. 4, 2025

(30) Foreign Application Priority Data
May 5, 2023 (EP) 23171824.8

(51) Int. Cl. H04L 9/32; H04L 9/30

(52) U.S. Cl. CPC H04L 9/3268; H04L 9/3073; H04L 9/3247

(57) ABSTRACT

Methods for providing an item of additional cryptographic information relating to a digital certificate including an item of post-quantum cryptographic information. The method includes: retrieving the item of additional cryptographic information; providing the item of additional cryptographic information; retrieving a further item of additional cryptographic information comprising a further item of additional post-quantum cryptographic information; and providing the further item of additional cryptographic information. The further item of additional cryptographic information: confirms a third public key belonging to a user for a third cryptographic algorithm in each case, and/or protects the digital certificate with a third digital signature of the issuer of the digital certificate in each case according to a third cryptographic signature method.

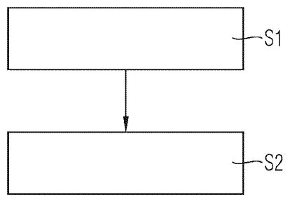

### CROSS-REFERENCE TO RELATED APPLICATIONS

This application is a U.S. National Stage Application of International Application No. PCT/EP2024/059982 filed Apr. 12, 2024, which designates the United States of America, and claims priority to EP Application No. 23171824.8 filed May 5, 2023, the contents of which are hereby incorporated by reference in their entirety.

### TECHNICAL FIELD

The present disclosure relates to digital certificates. Various embodiments of the teachings herein include systems and/or methods for providing at least one item of additional cryptographic information relating to a digital certificate.

### BACKGROUND

A digital certificate, for example according to X.509, confirms which user (identity) is assigned a particular public cryptographic key. As a result, the user can verify their identity when being authenticated using their private key and the associated public key. Digital certificates are also referred to as public key certificates.

With the introduction of new cryptographic algorithms, in particular the introduction of post-quantum-safe cryptographic algorithms, there is the need for a user to have a plurality of key pairs each consisting of a private key and a public key. These key pairs for different cryptographic algorithms may be used in hybrid cryptographic authentication protocols, or multiple authentication can be carried out using the keys of different cryptographic algorithms, or one of the existing keys or the supported cryptographic algorithms or a subset of the existing keys or the supported cryptographic algorithms can be selected.

It is known, in particular from ITU-T X.509:2019, that a digital certificate may contain a plurality of public keys and/or also a plurality of signatures which were formed using different algorithms. These certificates are also referred to as hybrid certificates or as composite certificates or as hybrid composite certificates. In this respect, the standard defines an extension containing this secondary cryptographic information which can also be referred to as additional cryptographic information (alternative public key and/or alternative signatures).

It is known from current standardization work (for example at IETF LAMPS) and from patent specifications (specifically ISARA U.S. Pat. Nos. 9,660,978 and 10,425,401) that a digital certificate can confirm a plurality of public keys belonging to a user and that a digital certificate may be protected by means of a plurality of digital signatures of the issuing certification authority. The second public key or the second digital signature is coded in an extension field of the certificate.

However, this secondary cryptographic information, that is to say the second public key belonging to the user and/or the second digital signature of the certificate, is therefore contained in the digital certificate itself. The approach, known from U.S. Pat. Nos. 9,660,978 and 10,425,401, of coding the additional information relating to a second public key belonging to the user, which is required for post-quantum crypto, or a second digital signature of the certificate in an extension field (certificate extension), has the disadvantage that this information enlarges the digital certificate. This enlarged certificate is then also transmitted to communication partners who do not require or cannot evaluate this additional information at all. In addition, the validation of the digital certificates is complex and therefore additionally susceptible to errors if it can be carried out on the target device. In addition, this approach scales poorly if a user has more than two public keys or if more than two digital signatures of the certificate are used.

In addition to digital certificates, attribute certificates are generally known. Attribute certificates confirm supplementary information/additional information (an attribute) relating to a user (also referred to as a “subject”) or relating to their digital certificate or a device belonging to a user. Attribute certificates are currently scarcely used in practice. Since a regular digital certificate often has a relatively long validity period (for example one or two years), different additional information can be provided in a protected manner using an attribute certificate that is valid for a shorter period.

Attribute certificates are sometimes also referred to as “authorization certificates”. In contrast to a regular digital certificate, an attribute certificate does not contain a public key. Instead, it contains a holder entry referring to the associated digital certificate. Three variants are specified, baseCertificateID, entityName and objectDigestInfo (that is to say using the serial number and issuer name of the certificate, using the username, or using a hash value). It is therefore known that an attribute certificate that does not confirm a public key refers to a digital certificate that confirms a public key.

### SUMMARY OF THE INVENTION

The teachings of the present disclosure include solutions for improved usability of a digital certificate which confirms a plurality of public keys belonging to a user and/or which is protected by means of a plurality of digital signatures of the issuing certification authority. For example, some embodiments include a method for providing at least one item of additional cryptographic information relating to a digital certificate, wherein the at least one item of additional cryptographic information is in the form of at least one item of additional post-quantum cryptographic information, wherein the digital certificate: has a first public key belonging to a user for a first cryptographic algorithm, and/or is protected with a first digital signature of an issuer of the digital certificate according to a first cryptographic signature method, wherein the at least one item of additional cryptographic information: in each case confirms a second public key belonging to a user for a second cryptographic algorithm in each case, and/or in each case protects the digital certificate with a second digital signature of the issuer of the digital certificate in each case according to a second cryptographic signature method, the method comprising: retrieving (S1) the at least one item of additional cryptographic information, wherein the at least one item of additional information is respectively retrieved from at least one attribute certificate assigned to the digital certificate, providing (S2) the at least one item of additional cryptographic information, retrieving at least one further item of additional cryptographic information, wherein the at least one further item of additional cryptographic information is in the form of at least one further item of additional post-quantum cryptographic information, wherein the at least one further item of additional information is respectively retrieved from at least one further attribute certificate assigned to the digital certificate, providing the at least one further item of additional cryptographic information, wherein the at least one further item of additional cryptographic information: in each case confirms a third public key belonging to a user for a third cryptographic algorithm in each case, and/or in each case protects the digital certificate with a third digital signature of the issuer of the digital certificate in each case according to a third cryptographic signature method.

In some embodiments, the at least one item of additional cryptographic information in each case confirms the second public key belonging to the user for the second cryptographic algorithm, and the method includes authenticating the user by means of a second private key assigned to the second public key.

In some embodiments, the at least one item of additional cryptographic information comprises a guideline.

In some embodiments, the at least one item of additional cryptographic information in each case confirms the second public key belonging to the user for the second cryptographic algorithm, wherein the guideline indicates at least one specification for using a second cryptographic key pair, wherein the second public key is associated with the second cryptographic key pair.

In some embodiments, the guideline indicates at least one specification for combined use of the second cryptographic key pair and a first cryptographic key pair, and the first public key is associated with the first cryptographic key pair.

In some embodiments, the at least one item of additional cryptographic information in each case protects the digital certificate with a second digital signature of the issuer of the digital certificate in each case according to a second cryptographic signature method, and the at least one attribute certificate has a link to the digital certificate.

In some embodiments, the link to the digital certificate is in the form of a cryptographic hash value of the digital certificate.

In some embodiments, the at least one item of additional information is respectively shown by the at least one attribute certificate.

As another example, some embodiments include a computer program product comprising a computer program, wherein the computer program can be loaded into a memory device of a computing unit, wherein one or more of the methods described herein are carried out with the computer program when the computer program is executed on the computing unit.

As another example, some embodiments include a computer-readable medium on which a computer program is stored, wherein the computer program can be loaded into a memory device of a computing unit, wherein one or more of the methods described herein are carried out with the computer program when the computer program is executed on the computing unit.

### BRIEF DESCRIPTION OF THE DRAWINGS

The teachings of the present disclosure become clear from the following explanations of exemplary embodiments and on the basis of the schematic drawing, in which:

The single FIGURE shows a flowchart of an example method incorporating teachings of the present disclosure.

### DETAILED DESCRIPTION

The teachings of the present disclosure include systems and methods for providing at least one item of additional cryptographic information relating to a digital certificate. For example, some embodiments include a method wherein the at least one item of additional cryptographic information is in the form of at least one item of additional post-quantum cryptographic information, wherein the digital certificate:
has a first public key belonging to a user for a first cryptographic algorithm, and/or
is protected with a first digital signature of an issuer of the digital certificate according to a first cryptographic signature method,
   wherein the at least one item of additional cryptographic information:
in each case confirms a second public key belonging to a user for a second cryptographic algorithm in each case, and/or
in each case protects the digital certificate with a second digital signature of the issuer of the digital certificate in each case according to a second cryptographic signature method, the method comprising the steps of:
retrieving the at least one item of additional cryptographic information,
wherein the at least one item of additional information is respectively retrieved from (in the sense of “out of”) at least one attribute certificate assigned to the digital certificate,
providing the at least one item of additional cryptographic information,
retrieving at least one further item of additional cryptographic information,
wherein the at least one further item of additional cryptographic information is in the form of at least one further item of additional post-quantum cryptographic information,
wherein the at least one further item of additional information is respectively retrieved from at least one further attribute certificate assigned to the digital certificate,
providing the at least one further item of additional cryptographic information,
   wherein the at least one further item of additional cryptographic information:
in each case confirms a third public key belonging to a user for a third cryptographic algorithm in each case, and/or
in each case protects the digital certificate with a third digital signature of the issuer of the digital certificate in each case according to a third cryptographic signature method.

The at least one item of additional cryptographic information can also be referred to as at least one item of secondary cryptographic information, in particular at least one item of additional post-quantum cryptographic information and/or at least one item of secondary post-quantum cryptographic information. The fact that the at least one item of additional cryptographic information, in particular, in each case protects the digital certificate with the second digital signature of the issuer of the digital certificate in each case according to a second cryptographic signature method means that the at least one item of additional cryptographic information is, in particular, in the form of the second digital signature.

The second digital signature according to the second cryptographic signature method protects the integrity and authenticity of the digital certificate. The at least one item of additional cryptographic information therefore confirms in each case, in particular, a single second public key belonging to a user for, in particular, a single second cryptographic algorithm in each case. This variant may be useful, in particular, if the at least one attribute certificate is present in multiple forms, that is to say there is not only one attribute certificate, but rather a plurality of attribute certificates for the certificate. If there are a plurality of attribute certificates, there are also a plurality of items of secondary cryptographic information.

In some embodiments, the at least one item of additional cryptographic information in each case confirms a plurality of second public keys belonging to a user for a plurality of second cryptographic algorithms. The at least one item of additional cryptographic information therefore in each case protects the digital certificate with, in particular, a single second digital signature of the issuer of the digital certificate in each case according to a single second cryptographic signature method, in particular. This variant may be useful, in particular, if the at least one attribute certificate is present in multiple forms, that is to say there is not only one attribute certificate, but rather a plurality of attribute certificates. If there are a plurality of attribute certificates, there are also a plurality of items of secondary cryptographic information.

In some embodiments, the at least one item of additional cryptographic information protects the digital certificate with a plurality of second digital signatures of the issuer of the digital certificate according to a plurality of second cryptographic signature methods. The digital certificate and also the at least one attribute certificate can therefore be protected with a single second digital signature, and/or can be protected by a multiplicity of second digital signatures.

In summary, there may be a plurality of attribute certificates, with the result that a plurality (in the sense of plural) or a multiplicity of second public keys belonging to the user can be confirmed, and/or with the result that there may be a plurality (in the sense of plural) or a multiplicity of second digital signatures of the digital certificate. This has the advantage (over a plurality of second public keys in an attribute certificate and/or a plurality of second digital signatures in an attribute certificate) that a user, depending on requirements, needs to transmit only the actually required attribute certificates, that is to say the actually required additional information relating to their digital certificate, to a communication partner.

Furthermore, further items of additional cryptographic information, that is to say relating to further second public keys belonging to the user and/or further second digital signatures of the digital certificate by the certificate issuer, can be subsequently formed and provided using an attribute certificate issued subsequently, that is to say at a later time than the issue of the digital certificate belonging to the user, during the validity of the digital certificate. These further items of information therefore need not be already available when the digital certificate itself is issued. In particular in the case of certificates with long-term validity, for example in the case of device certificates (IDevID) which are issued during device manufacture and are installed on the device, that further second signatures and/or further second public keys can be subsequently added to a digital certificate that has already been issued.

In summary, the disclosure provides, on the one hand, an alternative to the certificates patented by ISARA (U.S. Pat. Nos. 9,660,978 and 10,425,401). The approach has increased flexibility, with the result that this approach can also be used practically for a multiplicity of second public keys and/or a multiplicity of second digital signatures. Increased security may result from the storage of the additional cryptographic information being separated on the associated attribute certificate, rather than on the digital certificate itself.

Confirming an item of additional cryptographic information (for example additional post-quantum-crypto information) relating to a digital certificate in an attribute certificate assigned to the digital certificate. The digital certificate comprises a first public key belonging to a user for a first cryptographic algorithm. The digital certificate is protected with a first digital signature of the certificate issuer according to a first cryptographic signature method. The additional cryptographic information relating to the digital certificate, which is present as an attribute certificate, may (option 1) confirm a further public key belonging to the user for a further cryptographic method. The additional cryptographic information relating to the digital certificate, which is present as an attribute certificate, may (option 2) be a further digital signature of the digital certificate of a further cryptographic signature method.

In some embodiments, the at least one item of additional cryptographic information in each case confirms the second public key belonging to the user for the second cryptographic algorithm. The method comprises authenticating the user by means of a second private key assigned to the second public key. This may improve certificate-based user authentication. The digital certificate, for example according to X.509, confirms the user to whom the public key is assigned. The user can verify their identity by being authenticated with the second private key associated with the second public key. A first private key associated with the first public key can likewise be used for further authentication. A user may be, for example, a natural person, a legal person, a device, a device component, a machine, a vehicle or a software-based service, for example a web service or a website.

In some embodiments, the at least one item of additional cryptographic information comprises a guideline. The guideline can also be referred to as a policy.

In some embodiments, the at least one item of additional cryptographic information in each case confirms the second public key belonging to the user for the second cryptographic algorithm, wherein the guideline indicates at least one specification for using a second cryptographic key pair, wherein the second public key is associated with the second cryptographic key pair.

In some embodiments, the guideline indicates at least one specification for combined use of the second cryptographic key pair and a first cryptographic key pair, wherein the first public key is associated with the first cryptographic key pair. The specification for the combined use of the second cryptographic key pair and the first cryptographic key pair concerns, in particular, authentication of the user. This makes it possible to specify, for example, that the second cryptographic key pair and the first cryptographic key pair may be used only in combination, or it may be specified that they cannot be used in combination.

In some embodiments, the at least one item of additional cryptographic information in each case protects the digital certificate with a second digital signature of the issuer of the digital certificate in each case according to a second cryptographic signature method, wherein the at least one attribute certificate has a link to the digital certificate.

In some embodiments, the link to the digital certificate is in the form of a cryptographic hash value of the digital certificate.

In some embodiments, the at least one item of additional information is respectively shown by the at least one attribute certificate. The at least one item of additional information is therefore part of the at least one attribute certificate.

Some embodiments include a computer program product comprising a computer program, wherein the computer program can be loaded into a memory device of a computing unit, wherein one or more of the methods described herein are carried out with the computer program when the computer program is executed on the computing unit.

Some embodiments include a computer-readable medium on which a computer program is stored, wherein the computer program can be loaded into a memory device of a computing unit, wherein one or more of the methods described herein are carried out with the computer program when the computer program is executed on the computing unit.

The single FIGURE shows a flowchart of an example method incorporating teachings of the present disclosure for providing at least one item of additional cryptographic information relating to a digital certificate. The digital certificate has a first public key belonging to a user for a first cryptographic algorithm. The digital certificate is protected with a first digital signature of an issuer of the digital certificate according to a first cryptographic signature method.

The at least one item of additional cartographic information:
in each case confirms a second public key belonging to a user for a second cryptographic algorithm in each case, and/or
in each case protects the digital certificate with a second digital signature of the issuer of the digital certificate in each case according to a second cryptographic signature method.

The method comprises:
Step S1: retrieving the at least one item of additional cryptographic information, wherein the at least one item of additional information is respectively retrieved from (in the sense of “out of”) at least one attribute certificate assigned to the digital certificate,
Step S2: providing the at least one item of additional cryptographic information.

The method also comprises:
retrieving at least one further item of additional cryptographic information,
wherein the at least one further item of additional cryptographic information is in the form of at least one further item of additional post-quantum cryptographic information,
wherein the at least one further item of additional information is respectively retrieved from at least one further attribute certificate assigned to the digital certificate,
providing the at least one further item of additional cryptographic information,
   wherein the at least one further item of additional cryptographic information:
in each case confirms a third public key belonging to a user for a third cryptographic algorithm in each case, and/or
in each case protects the digital certificate with a third digital signature of the issuer of the digital certificate in each case according to a third cryptographic signature method.

RFC 5755 defines the following ASN.1 structure for an attribute certificate

AttributeCertificate::= SEQUENCE {

| | |
|---|---|
| acinfo | AttributeCertificateInfo, |
| signatureAlgorithm | AlgorithIdentifier, |
| signatureValue | BIT STRING |

```
        }
    AttributeCertificateInfo::= SEQUENCE {
```

| | |
|---|---|
| version | AttCertVersion -- |

version is v2,

| | |
|---|---|
| holder | Holder, |
| issuer | AttCertIssuer, |
| signature | AlgorithmIdentifier, |

```
          serialNumber
        CertificateSerialNumber,
```

| | |
|---|---|
| attrCertValidityPeriod | AttCertValidityPeriod, |
| attributes | SEQUENCE OF Attribute, |
| issuerUniqueID | UniqueIdentifier |

OPTIONAL,

| | |
|---|---|
| extensions | Extensions OPTIONAL |

```
        }
    Attribute::= SEQUENCE {
```

| | |
|---|---|
| type | AttributeType, |
| values | SET OF AttributeValue |
| | -- at least one value is |

required

}

```
    AttributeType::= OBJECT IDENTIFIER
    AttributeValue::= ANY DEFINED BY AttributeType
“AttributeType” can be used to provide an identification value
(ObjectIdentifier) which characterizes the corresponding
attributes for which the respective value is then indicated in the
context of the “AttributeValue”.
The “Object” identifier for the “AttributeType” can be defined
according to ITU-T X.509 as follows:
    id-SubjectAltCrypto OBJECT_IDENTIFIER::= { id-ce-
  SubjectAltCrpto }
The value of the “AttributeValue” is defined, for example, as
follows:
  SubjectAltCrypto ::= SEQUENCE {
```

| | |
|---|---|
| pkInfo | SubjectAltPublicKeyInfo, |
| combAND | boolean, |
| combOR | boolean, |

```
      ...
  }
```

“combAND” and “combOR” can be used to define whether both keys may be used only together or alternatively one of the two. This also enables flexible migration to a strong cryptographic method defined using the corresponding “AlgorithmIdentifier” of the “subjectAltPublicKeyInfo”. If “combAND” has been set, both methods are always used. If “combOR” has been set, only the key contained in the attribute certificate can also be used alone. If a plurality of attributes are used for a user certificate, a plurality of methods (more than 2) can therefore also be used using “combAND”. Furthermore, it is conceivable to implement a K out of N method; that is to say, in the case of 3 attribute certificates, 2 of 3 must be successfully used. For this purpose, the attribute certificate can then contain the value K as a numerical value (as an alternative or in addition to the attributes “combAND” and “combOR”).

The following elements have already been defined in ITU-T X.509 for regular certificates and can be used, according to the invention, to describe the attributes in an attribute certificate:

| subjectAltPublicKeyInfo EXTENSION ::= { | |
|---|---|
| SYNTAX | SubjectAltPublicKeyInfo, |
| IDENTIFIED BY | id-ce-subjectAltPublicKeyInfo |
| } | |
| SubjectAltPublicKeyInfo ::= SEQUENCE { | |
| algorithm | |
| AlgorithmIdentifier{{SupportedAlgorithms}}, | |
| subjectAltPublicKey | BIT STRING |

}

In an alternative variant, the defined attribute values are not used directly as an attribute, but rather as an extension of the attribute certificate under “Extensions”. “Extensions” are defined in ITU-T X.509 as follows:

| Extensions ::= SEQUENCE SIZE (1..MAX) OF Extension | |
|---|---|
| Extension ::= SEQUENCE { | |
| extnID | OBJECT IDENTIFIER, |
| critical | BOOLEAN DEFAULT FALSE, |
| extnValue | OCTET STRING |
| | -- contains the DER encoding of an ASN.1 |

value

-- corresponding to the extension type

identified

-- by extnID

}

The extension for indicating alternative cryptographic algorithms of other methods indicated in the same attribute certificate can be labeled “critical” or “non-critical”. This can be advantageously used in an extension. “extnID” then contains the defined identifier “id-ce-SubjectAltCrpto” and “extnValue” contains the corresponding coded structure “subjectAltCrypto”.

Although the teachings of the present disclosure have been described and illustrated more specifically in detail by means of the exemplary embodiments, the scope of the disclosure is not restricted by the disclosed examples and other variations can be derived therefrom by a person skilled in the art, without departing from the scope of protection thereof.

What is claimed is:

1. A method for providing an item of additional cryptographic information relating to a digital certificate, wherein the item of additional cryptographic information comprises at least one item of post-quantum cryptographic information, wherein the digital certificate:
has a first public key belonging to a user for a first cryptographic algorithm, and/or
is protected with a first digital signature of an issuer of the digital certificate according to a first cryptographic signature method,
wherein the item of additional cryptographic information:
confirms a second public key belonging to a user for a second cryptographic algorithm in each case, and/or
protects the digital certificate with a second digital signature of the issuer of the digital certificate in each case according to a second cryptographic signature method,
the method comprising:
retrieving the item of additional cryptographic information,
wherein the item of additional information is retrieved from an attribute certificate assigned to the digital certificate;
providing the item of additional cryptographic information;
retrieving a further item of additional cryptographic information comprising a further item of additional post-quantum cryptographic information,
wherein the further item of additional information is retrieved from a further attribute certificate assigned to the digital certificate;
providing the further item of additional cryptographic information,
wherein the further item of additional cryptographic information:
confirms a third public key belonging to a user for a third cryptographic algorithm in each case, and/or
protects the digital certificate with a third digital signature of the issuer of the digital certificate in each case according to a third cryptographic signature method.

2. The method as claimed in claim 1, further comprising:
authenticating the user by means of a second private key assigned to the second public key.

3. The method as claimed in claim 1, wherein the item of additional cryptographic information comprises a guideline.

4. The method as claimed in claim 3, wherein:
the item of additional cryptographic information confirms the second public key belonging to the user for the second cryptographic algorithm;
the guideline indicates a specification for using a second cryptographic key pair; and
the second public key is associated with the second cryptographic key pair.

5. The method as claimed in claim 4, wherein:
the guideline indicates a specification for combined use of the second cryptographic key pair and a first cryptographic key pair; and
the first public key is associated with the first cryptographic key pair.

6. The method as claimed in claim 1, wherein:
the item of additional cryptographic information protects the digital certificate with a second digital signature of the issuer of the digital certificate according to a second cryptographic signature method; and
the attribute certificate includes a link to the digital certificate.

7. The method as claimed in claim 6, wherein the link to the digital certificate comprises a cryptographic hash value of the digital certificate.

8. The method as claimed in claim 1, wherein the item of additional information is shown by the attribute certificate.

9-10. (canceled)
